(19) United States
(12) Patent Application Publication
(10) Pub. No.: US 2025/0275535 A1
(43) Pub. Date: Sep. 4, 2025

(54) OLIVE TREE BIOMASS EXTRACT

(71) Applicant: Veos Pharmaceuticals, S.L., Madrid (SP)

(72) Inventor: Bassam Damaj, Las Vegas, NV (US)

(21) Appl. No.: 19/065,645

(22) Filed: Feb. 27, 2025

Related U.S. Application Data
(60) Provisional application No. 63/560,177, filed on Mar. 1, 2024.

(51) Int. Cl. A01N 31/16; A01N 65/08; A01P 21/00; C05F 11/00

(52) U.S. Cl. CPC A01N 31/16; A01N 65/08; A01P 21/00; C05F 11/00

(57) ABSTRACT

Formulations of plant biostimulants, including hydroxytyrosol or its analogs, which may be derived from olive tree extracts, for agricultural use are described. Methods of increasing the germination rate of crop seeds are also described. Methods of making and using plant biostimulants are also described.

### CROSS-REFERENCE TO RELATED APPLICATIONS

This application claims the benefit of priority of U.S. Provisional Pat. Application No. 63/560,177, filed Mar. 1, 2024, which is hereby expressly incorporated by reference in its entirety.

### FIELD

The present disclosure generally relates to formulations for agricultural use comprising (i) olive tree extract or (ii) at least one bioactive compound found in olive tree extract. The present disclosure also generally relates to methods of increasing crop productivity by, for example, increasing germination rate of a crop seed, increasing protein production of crop seed, and/or improving stress tolerance and nutrient assimilation.

Certain aspects of the present disclosure relate to agricultural compositions and methods utilizing olive leaf extract containing hydroxytyrosol at a concentration of, for example but not limited to, approximately 12% to enhance plant growth, protein expression, stress tolerance, and nutrient assimilation and/or uptake efficiency. More specifically, this disclosure establishes an unexpected dose-dependent regulation, where concentrations above approximately 12% result in a metabolic desensitization effect, limiting protein production, contradicting conventional expectations.

### BACKGROUND

The olive tree is a subtropical broad-leaved evergreen tree which produces an edible fruit, commonly known as an olive. The botanical name of the most common olive tree is Olea europaea. It was first found in the Mediterranean region, but is also known to be cultivated in at least Australia, New Zealand, South Africa North America and South America. The olive fruit blossoms as green oval shaped fruit which then ripens to black in color after six to eight months. Another species of olive which is very common in the Indo-China region has the botanical name Canarium album also commonly known as “Chinese olive.”

Olive trees have economic impact, particularly in the regions in which they are cultivated. Olive trees are cultivated not only to yield the fruit, which may be commercialized, but also because of the commercial value of (i) oil extracted from the fruit and plant materials, (ii) wood of the olive tree, and (iii) olive tree leaf extract.

Olive leaf extracts, particularly those rich in hydroxytyrosol and polyphenols, have been documented for their antioxidant and biostimulant properties in plant systems. Previous studies suggested that higher concentrations of hydroxytyrosol would proportionally increase protein synthesis and stress tolerance in crops.

Olea europaea and Canarium album tree extracts contain a polyphenolic compound known as hydroxytyrosol. This compound in the extract is recognized as having medicinal benefits including as an anti-inflammatory agent, an antibacterial agent, and an antioxidant agent. Administration of olive tree extracts may lessen hypercholesterolemia, and this medicinal property may be the result of hydroxytyrosol reducing certain gut bacteria in the human gut (Conterno, 2019). Olive tree extracts may also work by changing the colonic microbial community in mice and hence counteract disorders associated with obesity (Wang, 2021). The olive tree extracts may also ameliorate oxidative stress and inflammation in different cells such as colon cancer cells, kidney cells and renal cells. Hydroxytyrosol is recognized to be beneficial for cardiovascular function. For example, hydroxytyrosol from olive trees may help reduce blood glucose level and improve blood insulin levels, lower systolic pressure and improve endothelial function of the heart (Violi, 2015; Davis, 2017). Moreover, hydroxytyrosol may also inhibits the monoamine oxidase and in turn helps treat Alzheimer's, Parkinson's and other neurological diseases (Bertelli, 2020; Sabrerizo, 2013).

Hydroxytyrosol has been used instead of preservatives in the meat product production industry due to its strong antibacterial and anti-fungal activity, and also because of its ability to protect and increase the bioavailability of necessary elements in the meat products and increase their nutritional properties (Martinez-Zamora, 2021).

### SUMMARY

Some embodiments of the present disclosure relate to a method of increasing the germination rate of a crop seed comprising: (i) applying a formulation comprising hydroxytyrosol, which may be obtained, typical as part of an extract, from an olive tree, typically from olive tree leaves and biomass, to the crop seed, wherein the formulation is effective for increasing the germination rate of a crop seed; and (ii) incubating the crop seed for a period ranging from about 1 day to about 75 days. In some embodiments, the formulation further comprises oleuropein. In some embodiments, incubating the crop seed is performed at a temperature range from about 20° C. to about 50° C. In some embodiments, the germination rate of the crop seed increases by at least about 20%, compared to incubating the crop seed only in water. In some embodiments, the method further comprises increasing the growth rate of the crop. In further embodiments, the growth rate of the crop increases by at least about 20%, compared to incubating the crop seed only in water.

Some embodiments relate to a formulation for agricultural use comprising hydroxytyrosol obtained from an olive tree, wherein the formulation is effective for increasing the germination rate of a crop seed. In some embodiments, the formulation further comprises an additive selected from the group consisting of surfactants, emulsifiers, wetting agents, drift retardants, and buffering agents. In some embodiments, the hydroxytyrosol concentration is from about 0.1% to about 20% by weight. In further embodiments, the hydroxytyrosol concentration is from about 0.1% to about 5% by weight. In some embodiments, the hydroxytyrosol concentration is about 0.5% by weight. In other embodiments, the hydroxytyrosol concentration is from about 8% to about 14% by weight. In further embodiments, the hydroxytyrosol concentration is about 12% by weight.

In some embodiments, the extract is obtained from olive tree leaves. In some embodiments, the extract is obtained from olive tree biomass. In certain embodiments, the extract is obtained from at least one of olive tree leaves, fruit, wood, bark, and combinations thereof. In some embodiments, the extract is obtained from olive pomace or olive mill wastewater. In some embodiments, the extract is obtained from olive pomace. In some embodiments, the extract is obtained from olive mill wastewater. In some embodiments, the extract is obtained from the leaf of an olive tree. In some embodiments, the olive tree is from the genus Canarium or the genus Olea. In some embodiments, the olive tree is from a species of Canarium album.

Some embodiments relate to the use of any of the formulations disclosed herein, which may be a biostimulant formulation, for increasing the growth rate of the crop. In some embodiments, the growth rate of the crop increases by at least about 20%, compared to incubating the crop seed only in water. In some embodiments, the crop is selected from the group consisting of leaf vegetables, fruit vegetables, root vegetables, flowers, fruit trees, and grains. In some embodiments, the use of any of the formulations disclosed herein may be for at least one of the following uses: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

Some embodiments relate to a composition comprising hydroxytyrosol obtained from an olive tree, wherein the hydroxytyrosol concentration is from about 0.1% to about 20% by weight, wherein the effect of the composition is at least one of the following: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop. In some embodiments, the extract is obtained from olive trees. In some embodiments, the extract is obtained from olive tree biomass. In certain embodiments, the extract is obtained from at least one of olive tree leaves, fruit, wood, bark, and combinations thereof. In some embodiments, the extract is obtained from the leaf of an olive tree. In some embodiments, the extract is obtained from the fruit of an olive tree. In some embodiments, the extract is obtained from the wood of an olive tree. In some embodiments, the extract is obtained from the bark of an olive tree. In some embodiments, the extract is obtained from olive pomace or olive mill wastewater. In some embodiments, the extract is obtained from olive pomace. In some embodiments, the extract is obtained from olive mill wastewater. In some embodiments, the olive tree is from the genus Canarium or the genus Olea. In some embodiments, the olive tree is from a species of Canarium album.

Some embodiments relate to a formulation for agricultural use comprising Formula (I):

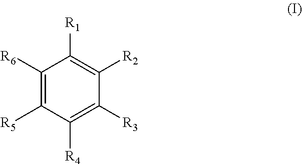

In some embodiments, R₁ is —CH₂CH₂OH; and each of R₂, R₃, R₄, R₅, and R₆ is independently selected from the group consisting of —H, —OH, and an optionally substituted C₁₋₆ heteroalkyl. In certain embodiments, R₂ is —H; at least one of R₃ and R₅ is —OH; R₄ is —OH; and R₆ is —H.

Some embodiments relate to a formulation for agricultural use comprising hydroxytyrosol. In some embodiments, the concentration of the hydroxytyrosol is from about 0.1% to about 20% by weight. In further embodiments, the concentration of the hydroxytyrosol is from about 0.1% to about 5% by weight. In certain embodiments, the concentration of the hydroxytyrosol is about 0.5% by weight. In other embodiments, the hydroxytyrosol concentration is from about 8% to about 14% by weight. In further embodiments, the hydroxytyrosol concentration is about 12% by weight. In other embodiments, the oleuropein concentration is about 20% by weight.

Some embodiments relate to a process for making a formulation for agricultural use from biomass comprising: hydrolyzing the biomass; filtering the biomass; and extracting hydroxytyrosol from the biomass, wherein the biomass comprises at least one of the following: olive pomace or olive mill wastewater. In some embodiments, the process further comprises heating the biomass at a temperature over about 75° C. In some embodiments, filtering the biomass comprises at least ultrafiltration or nanofiltration.

In some embodiments the formulation is a biostimulant formulations. In some embodiments, the formulation avoids metabolic suppression. In some embodiments, the formulation maximizes beneficial effects. In some embodiments, the formulations avoids metabolic suppression and maximizes beneficial effects.

Some embodiments disclosed herein relate to methods and compositions for improving protein expression. In some embodiments, the protein is a low molecular weight protein. In some embodiments, the protein is a heat shock protein (HSP). In some embodiments, the protein is HSP70. In some embodiments, the protein comprises HSP100. In some embodiments, the protein comprises one or more small heat shock proteins (sHSPs). In some embodiments, the protein is Rubisco. In some embodiments, the protein comprises one or more lipid transfer proteins (LTPs). In some embodiments, the protein comprises one or more dehydrins (LEA proteins). In some embodiments, the extract increases protein expression by up to about 10-fold. In some embodiments, the extract increases protein expression by up to about 5-fold. In some embodiments, the extract increases protein expression by between about 1-fold and 10-fold. In some embodiments, the extract increases protein expression by between about 1-fold and 5-fold.

Some embodiments disclosed herein relate to a biostimulant formulation. In some embodiments, the biostimulant formulation comprises an olive leaf extract; a polyphenol complex; and an aqueous or organic solvent carrier suitable for agricultural application.

In some embodiments, the olive leaf extract comprises hydroxytyrosol. In some embodiments, the hydroxytyrosol is derived from Olea europaca leaves. In some embodiments, the composition comprises less than about 24% hydroxytyrosol. In some embodiments, the composition comprises between about 6% and 24% hydroxytyrosol. In some embodiments, the composition comprises about 12% hydroxytyrosol.

In some embodiments, the polyphenol complex supports stress response and protein metabolism. In some embodiments, the polyphenol complex comprises one or more flavonols. In some embodiments, the one or more flavonols comprises quercetin, kaempferol, myricetin, fisetin and/or any combination thereof. In some embodiments, the polyphenol complex comprises one or more flavanes. In some embodiments, the one or more flavanes comprises epicatechin, epigallocatechin gallate, epigallocatechin and/or any combination thereof. In some embodiments, the polyphenol complex comprises one or more flavones. In some embodiments, the one or more flavones comprise apigenin, luteolin, chrysin, naringenin and/or any combination thereof. In some embodiments, the polyphenol complex comprises one or more anthocyanins. In some embodiments, the one or more anthocyanins comprise delphinidin, cyanidin, malvidin and/or any combination thereof. In some embodiments, the polyphenol complex comprises one or more flavanols. In some embodiments, the one or more flavanols comprise proanthocyanidins. In some embodiments, the polyphenol complex comprises one or more phenylpropanoids. In some embodiments, the one or more phenylpropanoids comprise rosmarinic acid, chlorogenic acid.

In some embodiments, the composition improves abiotic stress resistance. In some embodiments, the stress resistance comprises heat stress resistance. In some embodiments, the stress resistance comprises drought resistance. In some embodiments, the stress resistance comprises salinity resistance.

In some embodiments, the composition enhances crop growth.

In some embodiments, the composition enhances germination rates.

In some embodiments, the composition increases photosynthetic efficiency. Some embodiments disclosed herein relate to a method of increasing crop protein production. In some embodiments, the method comprises applying a formulation containing olive leaf extract with about 12% hydroxytyrosol by weight to a crop seed. In some embodiments, the method further comprises measuring protein expression. In some embodiments, the concentration of hydroxytyrosol is less than about 24% by weight.

Some embodiments disclosed herein relate to methods of improving crop stress resilience. In some embodiments, the method comprises applying a formulation containing olive leaf extract with about 12% hydroxytyrosol by weight to a crop seed. In some embodiments, applying the formulation to the crop seed increases production of one or more heat shock proteins (HSPs). In some embodiments, the one or more HSPs increase crop resilience to heat stress. and drought stress. In some embodiments, the one or more HSPs increase crop resilience to drought stress. In some embodiments, applying the formulation to the crop seed increases production of Rubisco. In some embodiments, applying the formulation to the crop seed increases photosynthetic efficiency of the crop. In some embodiments, applying the formulation to the crop seed increases crop yield. In some embodiments, the method further comprises regulating synthesis of one or more proteins to prevent overexpression or metabolic saturation. In some embodiments, the present disclosure is a practical application of the unexpected, and previously unrecognized and unappreciated, result that 12% hydroxytyrosol maximizes plant protein production and stress tolerance. In some embodiments, the present disclosure is a practical application of the unexpected, and previously unrecognized and unappreciated, result that higher concentrations (for example, 24%) of hydroxytyrosol trigger a suppression effect. In some embodiments, concentrations of hydroxytyrosol above approximately 12% by weight unexpectedly suppress protein production. These practical applications of one or more of these new and unexpected insight revolutionize polyphenol-based biostimulants, and establish new agricultural applications for hydroxytyrosol and its analogs.

### BRIEF DESCRIPTION OF THE FIGURES

FIG. 1A is a photographic image of corn seeds after being incubated in a solution according to one embodiment at room temperature for 14 days.

FIG. 1B is a photographic image of corn seeds after being incubated in water at room temperature for 14 days.

FIG. 1C is a bar chart showing the number of germinated and non-germinated corn seeds after being incubated in a solution according to one embodiment, relative to a control.

FIG. 1D is a bar chart showing the number of germinated and non-germinated corn seeds after being incubated in a solution according to one embodiment, relative to a control.

FIG. 2A is a photographic image of sorghum seeds after being incubated in a solution according to one embodiment at room temperature for 14 days.

FIG. 2B is a photographic image of sorghum seeds after being incubated in water at room temperature for 14 days.

FIG. 2C is a bar chart showing the number of germinated and non-germinated sorghum seeds after being incubated in a solution according to one embodiment, relative to a control.

FIG. 2D is a bar chart showing the number of germinated and non-germinated sorghum seeds after being incubated in a solution according to one embodiment, relative to a control.

FIG. 3A is a photographic image of rice seeds after being incubated in a solution according to one embodiment at 37° C. for 14 days.

FIG. 3B is a photographic image of rice seeds after being incubated in water at 37° C. for 14 days.

FIG. 4 is a line chart showing the column length of rice plants after being treated in a solution according to one embodiment, relative to a control.

FIG. 5 is an image of a western blot showing the protein levels in leaves, according to one embodiment, relative to a control.

FIG. 6 is a bar chart showing quantification of the fold change in protein expression according to one embodiment, relative to a control.

### DETAILED DESCRIPTION

The present disclosure provides methods of and formulations for increasing enhancing crop germination rates. In some embodiments, the present disclosure provides methods of and formulations for increasing the protein production of a crop. Some embodiments relate to methods of and formulation for agricultural use comprising hydroxytyrosol, alone or in combination with oleuropein. In some embodiments, the hydroxytyrosol is obtained from an olive tree or olive tree biomass. In some embodiments, the methods and formulations disclosed herein increase the growth rate of a crop. In further embodiments, the methods and formulations disclosed herein increase the protein production of a crop. In additional embodiments, the methods and formulations disclosed herein increase the crop yield, stress resistance, and/or photosynthetic efficiency.

Exogenous application of hydroxytyrosol can stimulate key metabolic pathways, such as the pentose phosphate pathway, leading to enhanced protein expression, improved germination rates, and greater resilience to abiotic stressors such as drought and heat. Phenolic compounds, including hydroxytyrosol, can activate plant defense responses and antioxidant mechanisms, promoting growth and survival under suboptimal conditions. Despite this knowledge, the impact of varying hydroxytyrosol concentrations on protein synthesis and stress tolerance in plants remains largely unexplored. While hydroxytyrosol's ability to enhance plant growth and metabolic function is recognized, little is known about its concentration-dependent effects. It is unknown if higher hydroxytyrosol concentrations would proportionally increase protein synthesis and stress resilience. Understanding this gap in knowledge is essential for the development of biostimulant formulations to maximize plant performance while avoiding potential metabolic saturation or feedback inhibition. The present disclosure aims to fill this knowledge gap by evaluating the dose-dependent effects of hydroxytyrosol on protein synthesis and abiotic stress responses in plants.

The present embodiments also provide formulation for agricultural use comprising Formula (I):

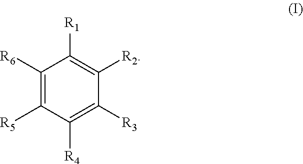

In some embodiments, R₁ is —CH₂CH₂OH; and each of R₂, R₃, R₄, R₅, and R₆ is independently selected from the group consisting of —H, —OH, and an optionally substituted C₁₋₆ heteroalkyl.

Some embodiments relate to a process for making a formulation for agricultural use from biomass. In some embodiments, the process comprises hydrolyzing the biomass; filtering the biomass; and extracting hydroxytyrosol from the biomass.

### Methods

Some disclosed embodiments relate to a method of increasing the germination rate of a crop seed. In some embodiments, the present disclosure relates to a method of enhancing uptake of nutrient by a crop. In some embodiments, the present disclosure relates to a method of improving soil microorganisms associated with a crop. In some embodiments, the present disclosure relates to a method of improving the tolerance to abiotic stress of a crop. In some embodiments, the present disclosure relates to a method of improving the health of a crop. In some embodiments, the present disclosure relates to a method of improving the vigor of a crop. In some embodiments, the present disclosure relates to a method of increasing the protein production of a crop. In some embodiments, the present disclosure relates to a method of increasing the harvest yield of a crop.

In some embodiments, the method comprises applying a formulation comprising hydroxytyrosol obtained from an olive tree to the crop seed. In some embodiments, the method comprises applying a formulation comprising hydroxytyrosol obtained from an olive tree to the crop. In some embodiments, the extract is obtained from olive trees. In some embodiments, the extract is obtained from olive tree biomass. In certain embodiments, the extract is obtained from at least one of olive tree leaves, fruit, wood, bark, and combinations thereof. In some embodiments, the extract is obtained from the leaf of an olive tree. In some embodiments, the extract is obtained from the fruit of an olive tree. In some embodiments, the extract is obtained from the wood of an olive tree. In some embodiments, the extract is obtained from the bark of an olive tree. In some embodiments, the extract is obtained from the biomass of an olive tree. In some embodiments, the extract is obtained from olive pomace or olive mill wastewater. In some embodiments, the extract is obtained from olive pomace. In some embodiments, the extract is obtained from olive mill wastewater. In some embodiments, the olive tree is from the genus Canarium or the genus Olea. In some embodiments, the olive tree is from the genus Canarium. In some embodiments, the olive tree is from the genus Olea. In some embodiments, the olive tree is from a species of Canarium album.

In some embodiments, the method further comprises incubating the crop seed for a period ranging from about 1 day to about 30 days. In some embodiments, the crop seed is incubated for, for about, at least, or at least about 1 day, about 2 days, about 3 days, about 4 days, about 5 days, about 6 days, about 7 days, about 8 days, about 9 days, about 10 days, about 11 days, about 12 days, about 13 days, about 14 days, about 15 days, about 16 days, about 17 days, about 18 days, about 19 days, about 20 days, about 21 days, about 22 days, about 23 days, about 24 days, about 25 days, about 26 days, about 27 days, about 28 days, about 29 days, about 30 days, about 31 days, about 32 days, about 33 days, about 34 days, about 35 days, about 36 days, about 37 days, about 38 days, about 39 days, about 40 days, about 41 days, about 42 days, about 43 days, about 44 days, about 45 days, about 46 days, about 47 days, about 48 days, about 49 days, about 50 days, about 51 days, about 52 days, about 53 days, about 54 days, about 55 days, about 56 days, about 57 days, about 58 days, about 59 days, about 60 days, about 61 days, about 62 days, about 63 days, about 64 days, about 66 days, about 67 days, about 68 days, about 70 days, about 71 days, about 72 days, about 75 days, about 75 days or longer if needed or any range of values therebetween. For example, in some embodiments, the crop seed is incubated for a period ranging from about 1 day to about 30 days; from about 1 day to about 75 days; from about 1 day to about 28 days; from about 7 days to about 45 days; or any range of values therebetween.

In some embodiments, the formulation is effective for increasing the germination rate of the crop seed. In some embodiments, the formulation is effective for enhancing uptake of nutrient by the crop. In some embodiments, the formulation is effective for improving soil microorganisms associated with the crop. In some embodiments, the formulation is effective for improving the tolerance to abiotic stress of the crop. In some embodiments, the formulation is effective for improving the health of the crop. In some embodiments, the formulation is effective for improving the vigor of the crop. In some embodiments, the formulation is effective for increasing the protein production of the crop. In some embodiments, the formulation is effective for increasing the harvest yield of the crop.

In some embodiments, the formulation is effective for: increasing the germination rate of a crop seed, enhancing nutrient uptake efficiency, improving soil microorganisms and microbial balance, and/or increasing protein production and overall crop yield. In some embodiments the germination rate increases by at least 20%, compared to untreated seeds. In some embodiments the germination rate increases by at least 20%, compared to untreated crops. In some embodiments, germination rate improvement is measured as percentage increase compared to untreated controls, observed improvement in root length, shoot length, and early vigor index, and/or the formulation is effective for crops selected from: leaf vegetables, fruit vegetables, root vegetables, flowers, fruit trees, and grains.

In some embodiments, hydroxytyrosol is applied at concentrations of 0.1% to 20% by weight, with 8% to 14% being preferred, and about 12% being most preferred. In some embodiments, oleuropein (if included) is applied at concentrations of up to 20% by weight, and preferably between 5% to 15%.

In some embodiments, the formulation increases photosynthetic efficiency by optimizing chlorophyll fluorescence, enhances crop resistance to one or more of: heat stress, drought tolerance, and/or salinity resistance. In some embodiments, the disclosed methods improve crop yield, potentially by 500% or more, depending on environmental conditions and application rate.

Some disclosed embodiments relate to a formulation for agricultural use, comprising: hydroxytyrosol and/or oleuropein, one or more agricultural adjuvants, such as: surfactants, emulsifiers, wetting agents, drift retardants, buffering agents.

In some embodiments, hydroxytyrosol and oleuropein are obtained, preferably by extraction from one or more of: olive tree biomass, including leaves, fruit, wood, and bark, olive pomace, and/or olive mill wastewater.

In some embodiments, incubating the crop seed is performed at a temperature range from about 20° C. to about 50° C. In some embodiments, the crop seed is incubated at a temperature range of, of about, of at least, or at least about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., or any range of values therebetween. For example, in some embodiments, the crop seed is incubated at in any one of the following ranges: from about 20° C. to about 50° C., from about 20° C. to about 25° C., from about 30° C. to about 55° C., from about 30° C. to about 40° C., from about 50° C. to about 60° C., or any range of values therebetween.

In some embodiments, the disclosed methods relate to increasing the germination rate of the crop seed. In some embodiments, the germination rate of the crop seed increases by, by about, by at least, or by least about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, about 200%, about 300%, about 400%, about 500%, or any range of values therebetween, compared to incubating the crop seed only in water. For example, in some embodiments, the germination rate of the crop seed increases by any one of the following ranges: from about 10% to about 20%, from about 60% to about 80%, from about 80% to about 90%, from about 200% to about 300%, or any range of values therebetween, compared to incubating the crop seed only in water.

In some embodiments, the disclosed methods relate to increasing the growth rate of the crop. In some embodiments, the growth rate of the crop increases by, by about, by at least, or by least about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, about 200%, about 300%, about 400%, about 500%, or any range of values therebetween, compared to incubating the crop seed only in water. For example, in some embodiments, the growth rate of the crop increases by any one of the following ranges: from about 10% to about 20%, from about 60% to about 80%, from about 80% to about 90%, from about 200% to about 300%, or any range of values therebetween, compared to incubating the crop seed only in water.

### Formulations

Some disclosed embodiments relate to a formulation for agricultural use. In some embodiments, the formulation comprises hydroxytyrosol. Some embodiments of the present disclosure relate to a formulation for agricultural use comprising hydroxytyrosol. In some embodiments, hydroxytyrosol is obtained from olive trees. In certain embodiments, hydroxytyrosol is obtained from an olive tree. In some embodiments, hydroxytyrosol is obtained from olive tree biomass. In certain embodiments, hydroxytyrosol is obtained from at least one of olive tree leaves, fruit, wood, bark, and combinations thereof. In some embodiments, hydroxytyrosol is obtained from the leaf of an olive tree. In some embodiments, hydroxytyrosol is obtained from the fruit of an olive tree. In some embodiments, hydroxytyrosol is obtained from the wood of an olive tree. In some embodiments, hydroxytyrosol is obtained from the bark of an olive tree. In some embodiments, hydroxytyrosol is obtained from the biomass of an olive tree. In some embodiments, hydroxytyrosol is obtained from olive pomace or olive mill wastewater. In some embodiments, hydroxytyrosol is obtained from olive pomace. In some embodiments, hydroxytyrosol is obtained from olive mill wastewater. In some embodiments, the olive tree is from the genus Canarium or the genus Olea. In some embodiments, the olive tree is from the genus Canarium. In some embodiments, the olive tree is from the genus Olea. In some embodiments, the olive tree is from a species of Canarium album.

In some embodiments, the formulation comprises hydroxytyrosol in a concentration of about 12% by weight (wt. %). In some embodiments, the formulation comprises hydroxytyrosol in a concentration of, of about, of at least, or at least about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, or any range of values therebetween. In some embodiments, the formulation comprises hydroxytyrosol in a concentration less than about 24 wt. %.

In some embodiments, the formulation comprises hydroxytyrosol in a concentration of any one of the following ranges: from about 1 wt. % to about 20 wt. %, from about 8 wt. % to about 16 wt. %, from about 10 wt. % to about 14 wt. %, from about 0.1 wt. % to about 24 wt. %, from about 0.1 wt. % to about 5 wt. %, from about 0.1 wt. % to about 20 wt. %, or any range of values therebetween. In some embodiments, the formulation comprises hydroxytyrosol in a concentration of about 0.1 wt. %. In some embodiments, the formulation comprises hydroxytyrosol in a concentration of about 0.5 wt. %. In some embodiments, the formulation comprises hydroxytyrosol in a concentration of about 1.5 wt. %. In some embodiments, the formulation comprises hydroxytyrosol in a concentration of about 12 wt. %. In some preferred embodiments, the formulation comprises hydroxytyrosol in a concentration of about 12 wt. % and oleuropein in a concentration of about 20 wt. %. In some embodiments, the formulation comprises hydroxytyrosol and oleuropein in a concentration of, of about, of at least, or at least about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, or any range of values therebetween. For example, in some embodiments, the formulation comprises hydroxytyrosol and oleuropein in a concentration of any one of the following ranges: from about 1 wt. % to about 20 wt. %, from about 8 wt. % to about 16 wt. %, from about 10 wt. % to about 14 wt. %, from about 0.1 wt. % to about 24 wt. %, from about 0.1 wt. % to about 5 wt. %, from about 0.1 wt. % to about 20 wt. %, or any range of values therebetween.

In some embodiments, the formulation comprises hydroxytyrosol and oleuropein in a concentration of about 0.1 wt. %. In some embodiments, the formulation comprises hydroxytyrosol and oleuropein in a concentration of about 0.5 wt. %. In some embodiments, the formulation comprises hydroxytyrosol and oleuropein in a concentration of about 1.5 wt. %. In some embodiments, the formulation comprises hydroxytyrosol and oleuropein in a concentration of about 12 wt. %. In some embodiments, the formulation comprises hydroxytyrosol and oleuropein in a concentration of less than about 24 wt. %.

In some embodiments, the formulation is used for at least one of the following uses: enhancing uptake of nutrient by a crop; improving soil microorganisms associated with the crop; improving the tolerance to abiotic stress of the crop; improving the health of the crop; improving the vigor of the crop; increasing the protein production of the crop; increasing the photosynthetic efficiency of the crop, and increasing the harvest yield of the crop. In some embodiments, the formulation is used for increasing the germination rate of the crop seed. In some embodiments, the formulation is used for enhancing uptake of nutrient by the crop. In some embodiments, the formulation is used for improving soil microorganisms associated with the crop. In some embodiments, the formulation is used for improving the tolerance to abiotic stress of the crop. In some embodiments, the formulation is used for improving the health of the crop. In some embodiments, the formulation is used for improving the vigor of the crop. In some embodiments, the formulation is used for increasing the protein production of the crop. In some embodiments, the formulation is used for increasing the harvest yield of the crop. In some embodiments, the formulation is used for increasing the photosynthetic efficiency of the crop.

In some embodiments, the crop is selected from the group consisting of leaf vegetables, fruit vegetables, root vegetables, flowers, fruit trees, and grains. In some embodiments, the crop is leaf vegetables. In some embodiments, the crop is fruit vegetables. In some embodiments, the crop is root vegetables. In some embodiments, the crop is flowers. In some embodiments, the crop is fruit trees. In some embodiments, the crop is grains.

In some embodiments, the formulation further comprises an additive selected from the group consisting of surfactants, emulsifiers, wetting agents, drift retardants, buffering agents, minerals, metals nutrients, and/or antioxidants (such as ascorbic acid).

In some embodiments, the disclosed formulation further comprises surfactants. Surfactants may be used, either alone or in combination with other one or more additives, such as mineral oil or a vegetable oil as an adjuvant. The types of surfactants used may depend generally on the nature and mode of action of the formulation. In some embodiments, the surfactants are non-ionics such as: alky ethoxylates, linear aliphatic alcohol ethoxylates, and aliphatic amine ethoxylates. Surfactants conventionally used in the art of formulations, and which may also be used in the present formulations, are described in Mccutcheon's Detergents and Emulsifiers Annual, MC Publishing Corp., Ridgewood, N.J., 1998, and in Encyclopedia of Surfactants, Vol. I-III, Chemical Publishing Co., New York, 1980-81. In some embodiments, the surfactants are selected from alkali metal, alkaline earth metal or ammonium salts of aromatic sulfonic acids, for example, ligno-, phenol-, naphthalene- and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl- or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, sorbitol esters, lignin-sulfite waste liquors or methylcellulose, or compositions of these.

In some embodiments, the formulation includes surfactants, either alone or in combination with other additives (e.g., mineral oil or vegetable oil as adjuvants). The type of surfactant used may depend on the formulation's intended application. In some embodiments, the surfactants are non-ionic surfactants, such as: alkyl ethoxylates, linear aliphatic alcohol ethoxylates, and/or aliphatic amine ethoxylates. Surfactants in known agrochemical formulations, which may also be incorporated into the present formulations, are described in Mccutcheon's Detergents and Emulsifiers Annual (MC Publishing Corp., Ridgewood, N.J., 1998) and Encyclopedia of Surfactants, Vol. I-III (Chemical Publishing Co., New York, 1980-81). In some embodiments, the formulation comprises alkali metal, alkaline earth metal, or ammonium salts of aromatic sulfonic acids, including lignosulfonates, phenolsulfonates, naphthalenesulfonates, dibutylnaphthalenesulfonates, and/or fatty acid arylsulfonates. Other surfactants that may be included include alkyl ethers, lauryl ethers, fatty alcohol sulfates, fatty alcohol glycol ether sulfates, and/or condensates of sulfonated naphthalene and its derivatives with formaldehyde.

In some embodiments, the disclosed formulation further comprises emulsifiers or emulsifying agents. An emulsifying agent is a substance, which stabilizes a suspension of droplets of one liquid phase in another liquid phase. Without the emulsifying agent the two liquids would separate into two immiscible liquid phases. In some embodiments, the most commonly used emulsifier blends include alkylphenol or aliphatic alcohol with 12 or more ethylene oxide units and the oil-soluble calcium salt of dodecylbenzene sulphonic acid. A range of hydrophile-lipophile balance (“HLB”) values from 8 to 18 will normally provide good stable emulsions. In some embodiments, the formulation further comprises emulsifiers to stabilize the suspension of droplets of one liquid phase in another. Without emulsifiers, the liquids would separate into immiscible phases. In some embodiments, emulsifier blends include: alkylphenol or aliphatic alcohol with at least 12 ethylene oxide units, and oil-soluble calcium salts of dodecylbenzene sulfonic acid. In some embodiments, the hydrophile-lipophile balance (HLB) value of the emulsifier ranges from 8 to 18, ensuring the formation of stable emulsions.

In some embodiments, the disclosed formulation further comprises wetting agents. A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules. In some embodiments, examples of wetting agents used in the formulation of the present disclosure, including wettable powders, suspension concentrates, and water-dispersible granule formulations are: sodium lauryl sulphate; sodium dioctyl sulphosuccinate; alkyl phenol ethoxylates; and aliphatic alcohol ethoxylates. In some embodiments, the formulation comprises wetting agents. A wetting agent reduces the interfacial tension between a liquid and a surface, allowing better spreading or penetration. Wetting agents serve two primary functions in agrochemical formulations: During production, wetting agents may enhance the wetting of powders in water to form concentrates for soluble liquids or suspension concentrates. During application, wetting agents may improve water penetration into wettable powders and water-dispersible granules. Examples of suitable wetting agents include: sodium lauryl sulfate, sodium dioctyl sulfosuccinate, alkyl phenol ethoxylates, and aliphatic alcohol ethoxylates.

In some embodiments, the disclosed formulation further comprises drift retardants. The drift retardants may comprise a single drift retardant or a mixture of two or more drift retardants. Drift retardants used may be water-soluble polymers, as for example polyacrylamides, acrylamide/acrylic acid polymers, sodium polyacrylate, carboxymethylcellulose, hydroxyethylcellulose, methylcellulose, polysaccharides, and natural and synthetic guar gum. It is also possible, furthermore, for certain emulsions or self-emulsifying systems to be used as drift retardants.

In some embodiments, the formulation comprises an antioxidant, such as for example, ascorbic acid (Vitamin C) or its derivatives to prevent oxidation of polyphenols, including hydroxytyrosol and oleuropein. In some embodiments, the antioxidant prevents the degradation of bioactive compounds during storage, transport, and application. In some embodiments, the concentration of ascorbic acid in the formulation is from about 0.01% to about 5% by weight, from about 0.05% to about 3% by weight, or from about 0.1% to about 2% by weight. In some embodiments, the formulation comprises ascorbic acid in a concentration of about 0.1 wt. % to about 1.5 wt. % to maximize oxidative stability. In some embodiments, the formulation includes a combination of ascorbic acid and other stabilizers, such as: citric acid, tocopherols (Vitamin E), or polyphenolic co-antioxidants.

In some embodiments, the disclosed formulation further comprises one or more buffering agents. In some embodiment, the pH of the formulation can be between pH 5.5-8.5. More specifically, the pH of the formulation can be between pH 5.5-6.0, between pH 5.75-6.25, between pH 6.0-6.5, between pH 6.25-6.75, between pH 6.5-7.0, between pH 6.75-7.25, between pH 7.0-7.5, between pH 7.5-8.0 or between pH 8.0-8.5. The pH of the formulation can be approximately pH 5.5, approximately pH 5.75, approximately pH 6.0, approximately pH 6.25, approximately pH 6.5, approximately pH 6.75, approximately pH 7.0, approximately pH 7.25, approximately pH 7.5, approximately pH 7.75, approximately pH 8.0, approximately pH 8.25, or approximately pH 8.5. The pH of the formulation can be adjusted using any acidic or basic agent. The pH of the formulation can be maintained using any compatible buffering agent or buffering system.

### Formula (I)

Some embodiments of the present disclosure relate to a formulation for agricultural use comprising Formula (I):

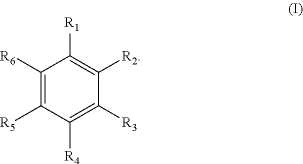

In some embodiments, R₁ is —CH₂CH₂OH. In some embodiments, each of R₂, R₃, R₄, R₅, and R₆ is independently selected from the group consisting of —H, —OH, and an optionally substituted C₁₋₆ heteroalkyl.

In some embodiments, R₂ is selected from the group consisting of —H, —OH, and an optionally substituted C₁₋₆ heteroalkyl. In some embodiments, R₂ is —H. In some embodiments, R₂ is —OH. In some embodiments, R₂ is an optionally substituted C₁₋₆ heteroalkyl.

In some embodiments, R₃ is selected from the group consisting of —H, —OH, and an optionally substituted C₁₋₆ heteroalkyl. In some embodiments, R₃ is —H. In some embodiments, R₃ is —OH. In some embodiments, R₃ is an optionally substituted C₁₋₆ heteroalkyl.

In some embodiments, R₄ is selected from the group consisting of —H, —OH, and an optionally substituted C₁₋₆ heteroalkyl. In some embodiments, R₄ is —H. In some embodiments, R₄ is —OH. In some embodiments, R₄ is an optionally substituted C₁₋₆ heteroalkyl.

In some embodiments, R₅ is selected from the group consisting of —H, —OH, and an optionally substituted C₁₋₆ heteroalkyl. In some embodiments, R₅ is —H. In some embodiments, R₅ is —OH. In some embodiments, R₅ is an optionally substituted C₁₋₆ heteroalkyl.

In some embodiments, R₆ is selected from the group consisting of —H, —OH, and an optionally substituted C₁₋₆ heteroalkyl. In some embodiments, R₆ is —H. In some embodiments, R₆ is —OH. In some embodiments, R₆ is an optionally substituted C₁₋₆ heteroalkyl.

In some embodiments, R₂ is —H; R₄ is —OH; and R₆ is —H. In further embodiments, at least one of R₃ and R₅ is —OH. In one embodiment, R₃ is —OH. In another embodiment, R₅ is —OH. In yet another embodiment, R₃ and R₅ are —OH.

In certain embodiments, the structure of Formula (I) is further represented by a formula selected from any one of the following compounds:

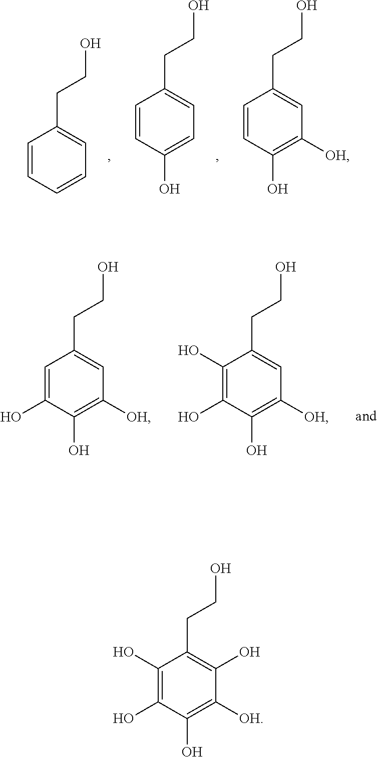 [SMILES: OCCc1ccccc1 ; OCCc1ccc(O)cc1 ; OCCc1ccc(O)c(O)c1 ; OCCc1cc(O)c(O)c(O)c1 ; OCCc1cc(O)c(O)c(O)c1O ; OCCc1c(O)c(O)c(O)c(O)c1O]

In some embodiments, the formulation comprises Formula (I) in a concentration of, of about, of at least, or at least about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, or any range of values therebetween. For example, in some embodiments, the formulation comprises Formula (I) in a concentration of any one of the following ranges: from about 1% to about 20%, from about 8% to about 16%, from about 10% to about 14%, from about 0.1% to about 24%, from about 0.1% to about 5%, from about 0.1% to about 20%, or any range of values therebetween. In some embodiments, the formulation comprises Formula (I) in a concentration of about 0.1 wt. %. In some embodiments, the formulation comprises Formula (I) in a concentration of about 0.5 wt. %. In some embodiments, the formulation comprises Formula (I) in a concentration of about 1.5 wt. %. In some embodiments, the formulation comprises Formula (I) in a concentration of about 12 wt. %. In some embodiments, the formulation comprises Formula (I) in a concentration less than about 24 wt. %.

### Processes for Making

Some disclosed embodiments of the present application relate to a process for making a formulation for agricultural use from biomass. In some embodiments, the process comprises hydrolyzing the biomass; filtering the biomass; and extracting hydroxytyrosol from the biomass. In some embodiments, the biomass comprises at least one of the following: olive pomace or olive mill wastewater. In some embodiments, the biomass comprises olive pomace. In some embodiments, the biomass comprises olive mill wastewater. In some embodiments, the biomass comprises olive pomace and olive mill wastewater. In some embodiments, the olive tree biomass includes leaves, fruit, wood, and/or bark. In some embodiments, to refine the extracted hydroxytyrosol and/or oleuropein, filtering the biomass comprises at least ultrafiltration or nanofiltration, or both. In some embodiments, filtering the biomass comprises only ultrafiltration. In some embodiments, filtering the biomass comprises nanofiltration. In some embodiments, filtering the biomass comprises ultrafiltration and nanofiltration.

In some embodiments, the process further comprises heating the biomass in a hydrolysis and extraction process. In some embodiments, the biomass is heated at a temperature range of, of about, of at least, or at least about 50° C., about 55° C., about 60° C., about 65° C., about 70° C., about 75° C., about 80° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 130° C., about 135° C., about 140° C., about 145° C., about 150° C., about 155° C., about 160° C., about 165° C., about 170° C., about 171° C., about 172° C., about 173° C., about 174° C., about 175° C., about 180° C., about 185° C., about 190° C., about 195° C., about 200° C., or any range of values therebetween. For example, in some embodiments, the crop seed is incubated at in any one of the following ranges: from about 95° C. to about 105° C., from about 80° C. to about 120° C., from about 173° C. to about 175° C., from about 90° C. to about 110° C., or any range of values therebetween.

In some embodiments, the process further comprises the hydrolysis of oleuropein. In some embodiments, the process comprises acidic hydrolysis of oleuropein. In some embodiments, the acid may include H₃PO₄, H₃PO₃, H₂SO₄, H₂SO₃, HNO₃, HNO₂, HI, HBr, HCl, HF, and combinations thereof.

In some embodiments, the process further comprises neutralizing the hydrolyzed oleuropein mixture. In some embodiments, the pH of the mixture is about 7.0 to about 9.0. In some embodiments, the pH of the mixture is about 7.5 to about 8.5. In some embodiments, the pH of the mixture is about 8.0.

### Additional Embodiments

In a disclosed embodiment, the method is a method of increasing the germination rate of a crop seed comprising: applying a formulation comprising hydroxytyrosol obtained from an olive tree to the crop seed, wherein the formulation is effective for increasing the germination rate of a crop seed; and incubating the crop seed for a period ranging from about 1 day to about 75 days.

In a disclosed embodiment, the method is a method of increasing the germination rate of a crop seed comprising: applying a formulation comprising hydroxytyrosol obtained from an olive tree to the crop seed, wherein the formulation is effective for increasing the germination rate of a crop seed; and incubating the crop seed for a period ranging from about 1 day to about 75 days, wherein incubating the crop seed is performed at a temperature range from about 20° C. to about 50° C.

In a disclosed embodiment, the method is a method of increasing the germination rate of a crop seed comprising: applying a formulation comprising hydroxytyrosol obtained from an olive tree to the crop seed, wherein the formulation is effective for increasing the germination rate of a crop seed; and incubating the crop seed for a period ranging from about 1 day to about 75 days, wherein the germination rate of the crop seed increases by at least about 20%, compared to incubating the crop seed only in water.

In a disclosed embodiment, the method is a method of increasing the germination rate of a crop seed comprising: applying a formulation comprising hydroxytyrosol obtained from an olive tree to the crop seed, wherein the formulation is effective for increasing the germination rate of a crop seed; and incubating the crop seed for a period ranging from about 1 day to about 30 days, further comprising increasing the growth rate of the crop.

In a disclosed embodiment, the method is a method of increasing the germination rate of a crop seed comprising: applying a formulation comprising hydroxytyrosol obtained from an olive tree to the crop seed, wherein the formulation is effective for increasing the germination rate of a crop seed; and incubating the crop seed for a period ranging from about 1 day to about 75 days, further comprising increasing the growth rate of the crop, wherein the growth rate of the crop increases by at least about 20%, compared to incubating the crop seed only in water.

In a disclosed embodiment, the formulation is a formulation for agricultural use comprising hydroxytyrosol obtained from an olive tree, wherein the formulation is effective for increasing the germination rate of a crop seed.

In a disclosed embodiment, the formulation is a formulation for agricultural use comprising hydroxytyrosol obtained from an olive tree, wherein the formulation is effective for increasing the germination rate of a crop seed, further comprising an additive selected from the group consisting of surfactants, emulsifiers, wetting agents, drift retardants, and buffering agents.

In a disclosed embodiment, the formulation is a formulation for agricultural use comprising hydroxytyrosol obtained from an olive tree, wherein the formulation is effective for increasing the germination rate of a crop seed, wherein the hydroxytyrosol concentration is from about 0.1% to about 20% by weight.

In a disclosed embodiment, the formulation is a formulation for agricultural use comprising hydroxytyrosol obtained from an olive tree, wherein the formulation is effective for increasing the germination rate of a crop seed, wherein the hydroxytyrosol concentration is from about 0.1% to about 20% by weight, wherein the hydroxytyrosol concentration is from about 0.1% to about 5% by weight.

In a disclosed embodiment, the formulation is a formulation for agricultural use comprising hydroxytyrosol obtained from an olive tree, wherein the formulation is effective for increasing the germination rate of a crop seed, wherein the hydroxytyrosol concentration is from about 0.1% to about 20% by weight, wherein the hydroxytyrosol concentration is from about 0.1% to about 5% by weight, wherein the hydroxytyrosol concentration is about 0.5% by weight.

In a disclosed embodiment, the formulation is a formulation for agricultural use comprising hydroxytyrosol obtained from an olive tree, wherein the formulation is effective for increasing the germination rate of a crop seed, wherein the hydroxytyrosol concentration is from about 0.1% to about 20% by weight, wherein the hydroxytyrosol concentration is from about 8% to about 14% by weight.

In a disclosed embodiment, the formulation is a formulation for agricultural use comprising hydroxytyrosol obtained from an olive tree, wherein the formulation is effective for increasing the germination rate of a crop seed, wherein the hydroxytyrosol concentration is from about 0.1% to about 20% by weight, wherein the hydroxytyrosol concentration is from about 8% to about 14% by weight, wherein the hydroxytyrosol concentration is about 12% by weight.

In a disclosed embodiment, the formulation is a formulation for agricultural use comprising hydroxytyrosol obtained from an olive tree, wherein the formulation is effective for increasing the germination rate of a crop seed, wherein the extract is obtained from an olive tree.

In a disclosed embodiment, the formulation is a formulation for agricultural use comprising hydroxytyrosol obtained from an olive tree, wherein the formulation is effective for increasing the germination rate of a crop seed, wherein the olive tree is from the genus Canarium or the genus Olea.

In a disclosed embodiment, the formulation is a formulation for agricultural use comprising hydroxytyrosol obtained from an olive tree, wherein the formulation is effective for increasing the germination rate of a crop seed, wherein the olive tree is from a species of Canarium album.

In a disclosed embodiment, the use of the formulation is a use for increasing the growth rate of the crop.

In a disclosed embodiment, the use of the formulation is a use for increasing the growth rate of the crop, wherein the growth rate of the crop increases by at least about 20%, compared to incubating the crop seed only in water.

In a disclosed embodiment, the use of the formulation is a use for increasing the growth rate of the crop, wherein the growth rate of the crop increases by at least about 20%, compared to incubating the crop seed only in water, wherein the crop is selected from the group consisting of leaf vegetables, fruit vegetables, root vegetables, flowers, fruit trees, and grains.

In a disclosed embodiment, the use of the formulation is a use for at least one of the following uses: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

In a disclosed embodiment applicable to hydroxytyrosol and oleuropein-based abiotic stress resistance and yield improvement, the composition comprises hydroxytyrosol, preferably obtained from an olive tree, wherein the hydroxytyrosol concentration is from about 0.1% to about 20% by weight and the oleuropein concentrations is from about 1% by weight to about 20% by weight, wherein the effect of the composition is at least one of the following: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

In a disclosed embodiment, the composition includes an extract obtained from an olive tree. In some embodiments, the composition includes an extract obtained from olive tree biomass. In some embodiments, the biostimulant composition enhances photosynthetic efficiency, measured using chlorophyll fluorescence (Fv/Fm) and CO₂ assimilation rate.

In a disclosed embodiment, the composition is a formulation for agricultural use comprising Formula (I):

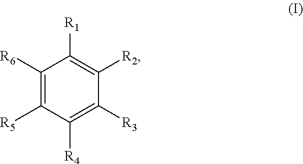

wherein: R₁ is —CH₂CH₂OH; and each of R₂, R₃, R₄, R₅, and R₆ is independently selected from the group consisting of —H, —OH, and an optionally substituted C₁₋₆ heteroalkyl.

In a disclosed embodiment, the process is a process for making a formulation for agricultural use from biomass comprising: hydrolyzing the biomass; filtering the biomass; and extracting hydroxytyrosol from the biomass, wherein the biomass comprises at least one of the following: olive pomace or olive mill wastewater.

In a disclosed embodiment, the process is a process for making a formulation for agricultural use from biomass comprising: hydrolyzing the biomass; filtering the biomass; and extracting hydroxytyrosol from the biomass, wherein the biomass comprises at least one of the following: olive pomace or olive mill wastewater, further comprising heating the biomass at a temperature over about 75° C.

In a disclosed embodiment, the process is a process for making a formulation for agricultural use from biomass comprising: hydrolyzing the biomass; filtering the biomass; and extracting hydroxytyrosol from the biomass, wherein the biomass comprises at least one of the following: olive pomace or olive mill wastewater, wherein filtering the biomass comprises at least ultrafiltration or nanofiltration.

Some embodiments disclosed herein relate to a biostimulant formulation. In some embodiments, the biostimulant formulation comprises an olive leaf extract; a polyphenol complex; and an aqueous or organic solvent carrier suitable for agricultural application. In some embodiments, the olive leaf extract comprises hydroxytyrosol. In some embodiments, the hydroxytyrosol is derived from Olea europaea leaves.

In some embodiments, the formulations disclosed herein comprise less than about 24% hydroxytyrosol. For example, in some embodiments, the formulation comprises about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23% or 24% by weight hydroxytyrosol, or comprises an amount of hydroxytyrosol that is in a range defined by any two of the preceding values. For example, in some embodiments, the formulation comprises between about 1% and 25%, 1% and 20%, 1% and 15%, 1% and 10%, 1% and 5%, 5% and 24%, 5% and 20%, 5% and 15%, 5% and 10%, 10% and 24%, 10% and 20%, 10% and 15%, 15% and 24%, 15% and 20% or 20% and 24% hydroxytyrosol by weight. In some embodiments, the formulations disclosed herein comprise about 12% hydroxytyrosol by weight.

In some embodiments, the formulations disclosed herein comprise a polyphenol complex. In some embodiments, the polyphenol complex supports stress response and protein metabolism. In some embodiments, the polyphenol complex comprises one or more flavonols. In some embodiments, the one or more flavonols comprises quercetin, kaempferol, myricetin, fisetin and/or any combination thereof. In some embodiments, the polyphenol complex comprises one or more flavanes. In some embodiments, the one or more flavanes comprises epicatechin, epigallocatechin gallate, epigallocatechin and/or any combination thereof. In some embodiments, the polyphenol complex comprises one or more flavones. In some embodiments, the one or more flavones comprise apigenin, luteolin, chrysin, naringenin and/or any combination thereof. In some embodiments, the polyphenol complex comprises one or more anthocyanins. In some embodiments, the one or more anthocyanins comprise delphinidin, cyanidin, malvidin and/or any combination thereof. In some embodiments, the polyphenol complex comprises one or more flavanols. In some embodiments, the one or more flavanols comprise proanthocyanidins. In some embodiments, the polyphenol complex comprises one or more phenylpropanoids. In some embodiments, the one or more phenylpropanoids comprise rosmarinic acid, chlorogenic acid.

Some embodiments disclosed herein are directed to a method of increasing crop protein production. In some embodiments, the method comprises applying a formulation containing olive leaf extract with hydroxytyrosol by weight to a crop seed. In some embodiments, the method further comprises measuring protein expression. In some embodiments, the concentration of hydroxytyrosol is less than about 24% by weight. For example, in some embodiments, the concentration of hydroxytyrosol is about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23% or 24% by weight hydroxytyrosol, or an amount of hydroxytyrosol that is in a range defined by any two of the preceding values. For example, in some embodiments, the concentration of hydroxytyrosol is between about 1% and 25%, 1% and 20%, 1% and 15%, 1% and 10%, 1% and 5%, 5% and 24%, 5% and 20%, 5% and 15%, 5% and 10%, 10% and 24%, 10% and 20%, 10% and 15%, 15% and 24%, 15% and 20% or 20% and 24% hydroxytyrosol by weight. In some embodiments, the concentration of hydroxytyrosol is about 12% hydroxytyrosol by weight.

In some embodiments, the methods disclosed herein increase expression of one or more proteins as compared to expression of the protein before the method is performed. In some embodiments, application of one or more formulations disclosed herein to a plant, crop or seed increases expression of one or more proteins as compared to expression of the protein before the formulation(s) are applied. In some embodiments, the formulations and methods disclosed herein increases expression of one or more proteins while preventing metabolic desensitization. In some embodiments, the proteins influenced by the formulation include: rubisco (ribulose-1,5-bisphosphate carboxylase/oxygenase); heat shock proteins (HSPs), including HSP70, HSP100, and small heat shock proteins (sHSPs); lipid transfer proteins (LTPs); and dehydrins (LEA proteins). In some embodiments, the protein comprises one or more heat shock proteins (HSPs). In some embodiments, the protein comprises HSP70. In some embodiments, the protein comprises HSP100. In some embodiments, the protein comprises one or more small heat shock proteins (sHSPs). In some embodiments, the protein comprises one or more lipid transfer proteins (LTPs). In some embodiments, the protein comprises one or more dehydrins (LEA proteins).

In some embodiments, the methods disclosed herein increase expression of one or more proteins as compared to expression of the protein before the method is performed. In some embodiments, application of one or more formulations to a crop, plant, or seed, increases expression of one or more proteins in the crop, plant, or seed as compared to expression of the protein before the formulation(s) is applied. In some embodiments, protein expression by up to about 10-fold. For example, in some embodiments, protein expression increases by up to about 1-fold, 2-fold, 3-fold, 4-fold, 5-fold, 6-fold, 7-fold, 8-fold, 9-fold, or 10-fold, or by an amount that is in a range defined by any two of the preceding values. For example, in some embodiments, protein expression increases by between about 1-fold and 10-fold, 1-fold and 7-fold, 1-fold and 5-fold, 1-fold and 3-fold, 3-fold and 10-fold, 3-fold and 7-fold, 3-fold and 5-fold, 5-fold and 10-fold, 5-fold and 7-fold, or 7-fold and 10-fold. In some embodiments, protein expression is increased by up to about 1000%. For example, in some embodiments, protein expression is increased by up to about 1%, 2%, 3%, 4%, 5%, 6%, 7%, 8%, 9%, 10%, 15%, 20%, 25%, 30%, 40%, 50%, 60%, 70%, 75%, 80%, 90%, 91%, 92%, 93%, 94%, 95%, 96%, 97%, 98%, 99%, 100%, 125%, 150%, 200%, 250%, 300%, 350%, 400%, 450%, 500%, 550%, 600%, 650%, 700%, 750%, 800%, 850%, 900%, 950% or 1000%, or by an amount that is in a range defined by any two of the preceding values. For example, in some embodiments, protein expression increases by between about 1-1000%, 1-750%, 1-500%, 1-250%, 1-100%, 1-75%, 1-50%, 1-25%, 1-10%, 10-1000%, 10-750%, 10-500%, 10-250%, 10-100%, 10-75%, 10-50%, 10-25%, 25-1000%, 25-750%, 25-500%, 25-250%, 25-100%, 25-75%, 25-50%, 50-1000%, 50-750%, 50-500%, 50-250%, 50-100%, 50-75%, 75-1000%, 75-500%, 75-250%, 75-100%, 100-1000%, 100-750%, 100-500%, 100-250%, 250-1000%, 250-750%, 250-500%, 500-1000%, 500-750% or 750-1000%.

In some embodiments, the methods disclosed herein increase resistance of the plant, crop, or seed to one or more stressors as compared to the resistance of the plant to the stressor before the method is carried out. In some embodiments, stress resistance is measured by biomass retention, chlorophyll content, relative water content (RWC), electrolyte leakage, and survival rate under stress conditions. Heat stress resistance is measured using chlorophyll fluorescence (Fv/Fm) and electrolyte leakage (%). Drought resistance may be measured using relative water content (RWC, %), stomatal conductance (mol m⁻² s⁻¹), and biomass retention (%). Salinity resistance may be measured using sodium accumulation (mg/g dry weight), plant growth inhibition (%), and relative water content (RWC, %). In some embodiments, stress resistance increases by up to 100%. For example, in some embodiments, stress resistance increases by 5%, 10%, 20%, 30%, 40%, 50%, 60%, 70%, 80%, 90%, or 100%, or by a range defined by any two of these values.

In some embodiments, the methods disclosed herein increase crop growth as compared to crop growth prior to performing the method. In some embodiments, application of one or more formulations disclosed herein to a crop, plant, or seed, increases crop growth as compared to growth of the crop prior to application of the formulation. In some embodiments, crop growth may be measured in terms of plant height (cm), biomass accumulation (g dry weight per plant), and leaf area index (LAI, m²/m²). Plant height increase may be measured in centimeters (cm). Biomass increase may be measured in grams (g) per plant (dry weight). Leaf area index (LAI) may be measured as m² of leaf area per m² of ground area. In some embodiments, crop growth increases by up to 300%. For example, in some embodiments, crop growth increases by 5%, 10%, 20%, 30%, 40%, 50%, 60%, 75%, 100%, 150%, 200%, 250%, or 300%, or by a range defined by any two of these values.

In some embodiments, crop growth is increased by up to about 10-fold. For example, in some embodiments, crop growth increases by up to about 1-fold, about 2-fold, about 3-fold, about 4-fold, about 5-fold, about 6-fold, about 7-fold, about 8-fold, about 9-fold, or about 10-fold, or by an amount that is in a range defined by any two of the preceding values. For example, in some embodiments, crop growth increases by between about 1-fold and about 10-fold, about 1-fold and about 7-fold, about 1-fold and about 5-fold, about 1-fold and about 3-fold, about 3-fold and about 10-fold, about 3-fold and about 7-fold, about 3-fold and about 5-fold, about 5-fold and about 10-fold, about 5-fold and about 7-fold, or about 7-fold and about 10-fold. In some embodiments, crop growth is increased by up to about 1000%. For example, in some embodiments, crop growth is increased by up to about 1%, 2%, 3%, 4%, 5%, 6%, 7%, 8%, 9%, 10%, 15%, 20%, 25%, 30%, 40%, 50%, 60%, 70%, 75%, 80%, 90%, 91%, 92%, 93%, 94%, 95%, 96%, 97%, 98%, 99%, 100%, 125%, 150%, 200%, 250%, 300%, 350%, 400%, 450%, 500%, 550%, 600%, 650%, 700%, 750%, 800%, 850%, 900%, 950% or 1000%, or by an amount that is in a range defined by any two of the preceding values. For example, in some embodiments, crop growth increases by between about 1-1000%, 1-750%, 1-500%, 1-250%, 1-100%, 1-75%, 1-50%, 1-25%, 1-10%, 10-1000%, 10-750%, 10-500%, 10-250%, 10-100%, 10-75%, 10-50%, 10-25%, 25-1000%, 25-750%, 25-500%, 25-250%, 25-100%, 25-75%, 25-50%, 50-1000%, 50-750%, 50-500%, 50-250%, 50-100%, 50-75%, 75-1000%, 75-500%, 75-250%, 75-100%, 100-1000%, 100-750%, 100-500%, 100-250%, 250-1000%, 250-750%, 250-500%, 500-1000%, 500-750% or 750-1000%.

In some embodiments, the methods disclosed herein increase crop yield. In some embodiments, application of one or more formulations disclosed herein to a crop, plant, or seed, increases crop yield. In some embodiments, crop yield may be measured as grain yield (kg/ha or tons/ha), fruit yield (tons/ha), and total dry biomass yield (g per plant or tons/ha). Grain yield may be measured in kilograms per hectare (kg/ha) or tons per hectare (tons/ha). Fruit yield may be measured in tons per hectare (tons/ha). Total dry biomass yield may be measured in grams per plant (g/plant) or tons per hectare (tons/ha). In some embodiments, crop yield increases by up to 500%. For example, in some embodiments, crop yield increases by 5%, 10%, 20%, 30%, 40%, 50%, 75%, 100%, 200%, 300%, 400%, or 500%, or by a range defined by any two of these values.

In some embodiments, crop yield is increased by up to about 10-fold. For example, in some embodiments, crop yield increases by up to about 1-fold, about 2-fold, about 3-fold, about 4-fold, about 5-fold, about 6-fold, about 7-fold, about 8-fold, about 9-fold, or about 10-fold, or by an amount that is in a range defined by any two of the preceding values. For example, in some embodiments, crop yield increases by between about 1-fold and about 10-fold, about 1-fold and about 7-fold, about 1-fold and about 5-fold, about 1-fold and about 3-fold, about 3-fold and about 10-fold, about 3-fold and about 7-fold, about 3-fold and about 5-fold, about 5-fold and about 10-fold, about 5-fold and about 7-fold, or about 7-fold and about 10-fold. In some embodiments, crop yield is increased by up to about 1000%. For example, in some embodiments, crop yield is increased by up to about 1%, 2%, 3%, 4%, 5%, 6%, 7%, 8%, 9%, 10%, 15%, 20%, 25%, 30%, 40%, 50%, 60%, 70%, 75%, 80%, 90%, 91%, 92%, 93%, 94%, 95%, 96%, 97%, 98%, 99%, 100%, 125%, 150%, 200%, 250%, 300%, 350%, 400%, 450%, 500%, 550%, 600%, 650%, 700%, 750%, 800%, 850%, 900%, 950% or 1000%, or by an amount that is in a range defined by any two of the preceding values. For example, in some embodiments, crop yield increases by between about 1-1000%, 1-750%, 1-500%, 1-250%, 1-100%, 1-75%, 1-50%, 1-25%, 1-10%, 10-1000%, 10-750%, 10-500%, 10-250%, 10-100%, 10-75%, 10-50%, 10-25%, 25-1000%, 25-750%, 25-500%, 25-250%, 25-100%, 25-75%, 25-50%, 50-1000%, 50-750%, 50-500%, 50-250%, 50-100%, 50-75%, 75-1000%, 75-500%, 75-250%, 75-100%, 100-1000%, 100-750%, 100-500%, 100-250%, 250-1000%, 250-750%, 250-500%, 500-1000%, 500-750% or 750-1000%.

In some embodiments, the methods disclosed herein increase germination rates. In some embodiments, application of one or more formulations disclosed herein to a crop, plant, or seed, increases germination rates. In some embodiments, germination rate may be measured as the percentage of seeds that successfully germinate over a set period (germination percentage, %). Germination rate may be measured as percentage (%) of seeds that germinate within a given timeframe. Time to germination may be measured in days. In some embodiments, germination rate increases by up to 200%. For example, in some embodiments, germination rate increases by 5%, 10%, 20%, 30%, 40%, 50%, 75%, 100%, 150%, or 200%, or by a range defined by any two of these values.

In some embodiments, germination rate is increased by up to about 10-fold. For example, in some embodiments, germination rate increases by up to about 1-fold, about 2-fold, about 3-fold, about 4-fold, about 5-fold, about 6-fold, about 7-fold, about 8-fold, about 9-fold, or about 10-fold, or by an amount that is in a range defined by any two of the preceding values. For example, in some embodiments, germination rate increases by between about 1-fold and about 10-fold, about 1-fold and about 7-fold, about 1-fold and about 5-fold, about 1-fold and about 3-fold, about 3-fold and about 10-fold, about 3-fold and about 7-fold, about 3-fold and about 5-fold, about 5-fold and about 10-fold, about 5-fold and about 7-fold, or about 7-fold and about 10-fold. In some embodiments, germination rate is increased by up to about 1000%. For example, in some embodiments, germination rate is increased by up to about 1%, 2%, 3%, 4%, 5%, 6%, 7%, 8%, 9%, 10%, 15%, 20%, 25%, 30%, 40%, 50%, 60%, 70%, 75%, 80%, 90%, 91%, 92%, 93%, 94%, 95%, 96%, 97%, 98%, 99%, 100%, 125%, 150%, 200%, 250%, 300%, 350%, 400%, 450%, 500%, 550%, 600%, 650%, 700%, 750%, 800%, 850%, 900%, 950% or 1000%, or by an amount that is in a range defined by any two of the preceding values. For example, in some embodiments, germination rate increases by between about 1-1000%, 1-750%, 1-500%, 1-250%, 1-100%, 1-75%, 1-50%, 1-25%, 1-10%, 10-1000%, 10-750%, 10-500%, 10-250%, 10-100%, 10-75%, 10-50%, 10-25%, 25-1000%, 25-750%, 25-500%, 25-250%, 25-100%, 25-75%, 25-50%, 50-1000%, 50-750%, 50-500%, 50-250%, 50-100%, 50-75%, 75-1000%, 75-500%, 75-250%, 75-100%, 100-1000%, 100-750%, 100-500%, 100-250%, 250-1000%, 250-750%, 250-500%, 500-1000%, 500-750% or 750-1000%.

In some embodiments, the methods disclosed herein increase photosynthetic efficiency. In some embodiments, application of one or more formulations disclosed herein to a crop, plant, or seed, increases photosynthetic efficiency. In some embodiments, photosynthetic efficiency may be measured using chlorophyll fluorescence (Fv/Fm), photosynthetic rate (μmol CO₂ m⁻² s⁻¹), and stomatal conductance (mol H₂O m⁻² s⁻¹). Chlorophyll fluorescence (Fv/Fm) ratio may be used to measure the efficiency of Photosystem II. Photosynthetic rate is measured in micromoles of CO₂ uptake per square meter per second (μmol CO₂ m⁻² s⁻¹). Stomatal conductance may be measured in moles of H₂O per square meter per second (mol H₂O m⁻² s⁻¹). In some embodiments, photosynthetic efficiency increases by up to 150%. For example, in some embodiments, photosynthetic efficiency increases by 5%, 10%, 20%, 30%, 40%, 50%, 75%, 100%, or 150%, or by a range defined by any two of these values.

In some embodiments, photosynthetic efficiency is increased by up to about 10-fold. For example, in some embodiments, photosynthetic efficiency increases by up to about 1-fold, about 2-fold, about 3-fold, about 4-fold, about 5-fold, about 6-fold, about 7-fold, about 8-fold, about 9-fold, or about 10-fold, or by an amount that is in a range defined by any two of the preceding values. For example, in some embodiments, photosynthetic efficiency increases by between about 1-fold and about 10-fold, about 1-fold and about 7-fold, about 1-fold and about 5-fold, about 1-fold and about 3-fold, about 3-fold and about 10-fold, about 3-fold and about 7-fold, about 3-fold and about 5-fold, about 5-fold and about 10-fold, about 5-fold and about 7-fold, or about 7-fold and about 10-fold. In some embodiments, photosynthetic efficiency is increased by up to about 1000%. For example, in some embodiments, germination rate is increased by up to about 1%, 2%, 3%, 4%, 5%, 6%, 7%, 8%, 9%, 10%, 15%, 20%, 25%, 30%, 40%, 50%, 60%, 70%, 75%, 80%, 90%, 91%, 92%, 93%, 94%, 95%, 96%, 97%, 98%, 99%, 100%, 125%, 150%, 200%, 250%, 300%, 350%, 400%, 450%, 500%, 550%, 600%, 650%, 700%, 750%, 800%, 850%, 900%, 950% or 1000%, or by an amount that is in a range defined by any two of the preceding values. For example, in some embodiments, photosynthetic efficiency increases by between about 1-1000%, 1-750%, 1-500%, 1-250%, 1-100%, 1-75%, 1-50%, 1-25%, 1-10%, 10-1000%, 10-750%, 10-500%, 10-250%, 10-100%, 10-75%, 10-50%, 10-25%, 25-1000%, 25-750%, 25-500%, 25-250%, 25-100%, 25-75%, 25-50%, 50-1000%, 50-750%, 50-500%, 50-250%, 50-100%, 50-75%, 75-1000%, 75-500%, 75-250%, 75-100%, 100-1000%, 100-750%, 100-500%, 100-250%, 250-1000%, 250-750%, 250-500%, 500-1000%, 500-750% or 750-1000%.

In some embodiments, the formulation comprises no more than 24% hydroxytyrosol by weight. In some embodiments, increasing the concentration of hydroxytyrosol in the formulation to greater than about 24% by weight unexpectedly suppresses production of one or more proteins. In some embodiments, the proteins influenced by the formulation include: rubisco (ribulose-1,5-bisphosphate carboxylase/oxygenase); heat shock proteins (HSPs), including HSP70, HSP100, and small heat shock proteins (sHSPs); lipid transfer proteins (LTPs); and dehydrins (LEA proteins). In some embodiments, the protein comprises one or more heat shock proteins (HSPs). In some embodiments, the protein comprises HSP70. In some embodiments, the protein comprises HSP100. In some embodiments, the protein comprises one or more small heat shock proteins (sHSPs). In some embodiments, the protein comprises one or more lipid transfer proteins (LTPs). In some embodiments, the protein comprises one or more dehydrins (LEA proteins). In some embodiments, increasing the concentration of hydroxytyrosol to greater than 24% by weight suppresses crop growth rate, crop yield, germination rate, stress response resistance, photosynthetic efficiency and/or any combination thereof.

### Numbered Arrangements

Some embodiments provided herein are described by way of the following provided numbered arrangements, and are also provided as possible combinations or overlapping embodiments:

1. A method of increasing the germination rate of a crop seed comprising:
applying a formulation comprising hydroxytyrosol to the crop seed, wherein the formulation is effective for increasing the germination rate of a crop seed; and
incubating the crop seed for a period ranging from about 1 day to about 30 days.

2. The method of arrangement 1, wherein the formulation further comprises oleuropein.

3. The method arrangement 1, wherein incubating the crop seed is performed at a temperature range from about 20° C. to about 50° C.

4. The method Arrangement 1, wherein the germination rate of the crop seed increases by at least about 20%, compared to incubating the crop seed only in water.

5. The method arrangement 1, further comprising increasing the growth rate of the crop.

6. The method arrangement 5, wherein the growth rate of the crop increases by at least about 20%, compared to incubating the crop seed only in water.

7. A formulation for agricultural use comprising hydroxytyrosol, wherein the formulation is effective for increasing the germination rate of a crop seed.

8. The formulation of arrangement 7, wherein the formulation further comprises oleuropein.

9. The formulation of arrangement 8, further comprising an additive selected from the group consisting of surfactants, emulsifiers, wetting agents, drift retardants, and buffering agents.

10. The formulation of arrangement 7, wherein the hydroxytyrosol concentration is from about 0.1% to about 20% by weight.

11. The formulation of arrangement 10, wherein the hydroxytyrosol concentration is from about 0.1% to about 5% by weight.

12. The formulation of arrangement 11, wherein the hydroxytyrosol concentration is about 0.5% by weight.

13. The formulation of arrangement 10, wherein the hydroxytyrosol concentration is from about 8% to about 14% by weight.

14. The formulation of arrangement 13, wherein the hydroxytyrosol concentration is about 12% by weight.

15. The formulation of arrangement 7, wherein the hydroxytyrosol concentration is below a level that suppresses protein expression.

16. The formulation of arrangement 8, wherein the oleuropein concentration is about 20% by weight

17. The formulation of arrangement 7, wherein hydroxytyrosol is obtained from olive tree biomass.

18. The formulation of arrangement 17, wherein the olive tree is from the genus Canarium or the genus Olea.

19. The formulation of arrangement 17, wherein the olive tree is from a species of Canarium album.

20. The use of the formulation of any one of arrangements 7-19 for increasing the growth rate of the crop.

21. The use of arrangement 20, wherein the growth rate of the crop increases by at least about 20%, compared to incubating the crop seed only in water.

22. The use of arrangement 20, wherein the crop is selected from the group consisting of leaf vegetables, fruit vegetables, root vegetables, flowers, fruit trees, and grains.

23. The use of the formulation of any one of arrangements 7-19 for at least one of the following uses: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

24. A composition comprising hydroxytyrosol obtained from an olive tree,
wherein the hydroxytyrosol concentration is from about 0.1% to about 20% by weight,
wherein the effect of the composition is at least one of the following: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

25. A formulation for agricultural use comprising Formula (I):

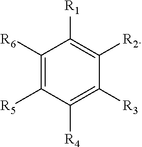

### EXAMPLES

Example embodiments of the present disclosure, including processes, materials and/or resultant products, are described in the following examples.

### Example 1—Corn Seed Germination

Corn seeds (field hybrid 7571) were incubated at room temperature in a solution including 12 wt. % hydroxytyrosol for 14 days. As a control, corn seeds (field hybrid 7571) were incubated at room temperature in water for 14 days.

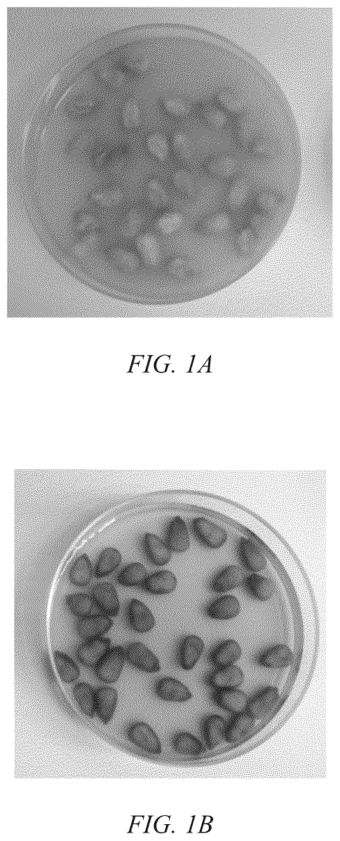

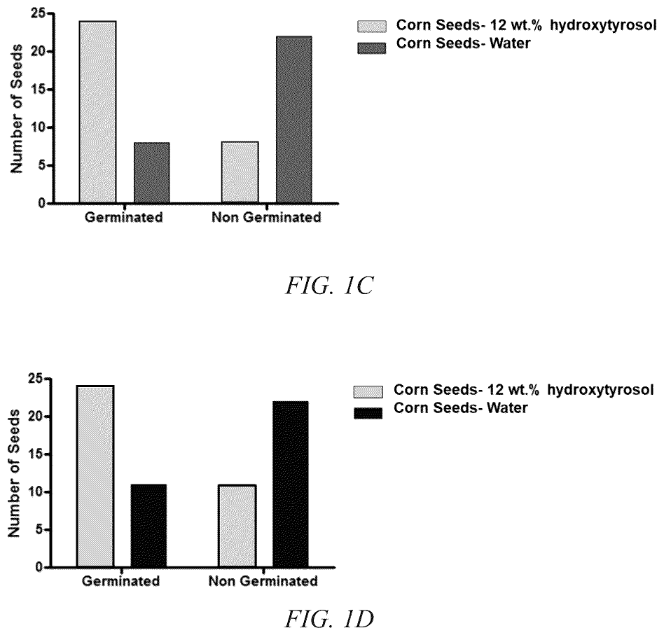

FIG. 1A depicts a photographic image of the corn seeds incubated in the 12 wt. % hydroxytyrosol solution after 14 days. FIG. 1B is a photographic image of the corn seeds incubated in water after 14 days. As observed in FIGS. 1A and 1B, a greater number of germ tubes emerged from the corn seeds that were incubated in the 12 wt. % hydroxytyrosol solution, compared to the corn seeds incubated in water. For example, FIG. 1C is a bar chart showing the number of germinated and non-germinated corn seeds after being incubated in the 12 wt. % hydroxytyrosol solution, relative to the control. As observed in FIG. 1C, 75% of the corn seeds incubated in the 12 wt. % hydroxytyrosol solution germinated, compared to 27% of the corn seeds incubated in water.

Consistent results were observed when the above-described protocol was repeated. For example, as observed in FIG. 1D, 69% of the corn seeds incubated in the 12 wt. % hydroxytyrosol solution germinated, compared to 33% of the corn seeds incubated in water. Moreover, the solutions including 12 wt. % hydroxytyrosol inhibited bacterial growth, compared to samples incubated in water.

### Example 2—Sorghum Seed Germination

Sorghum seeds (RT X 437) were incubated at room temperature in a solution including 12 wt. % hydroxytyrosol for 14 days. As a control, sorghum seeds (RT X 437) were incubated at room temperature in water for 14 days.

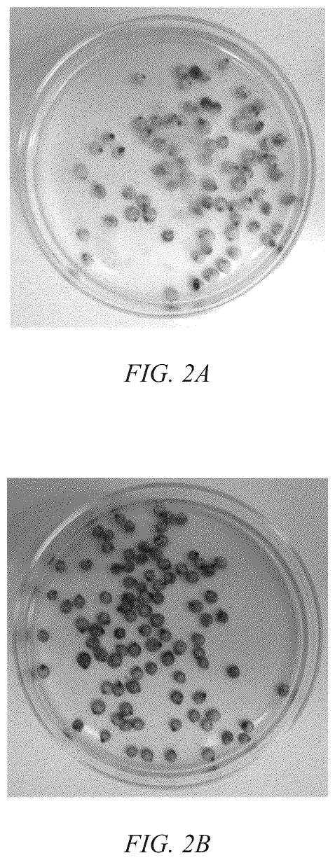

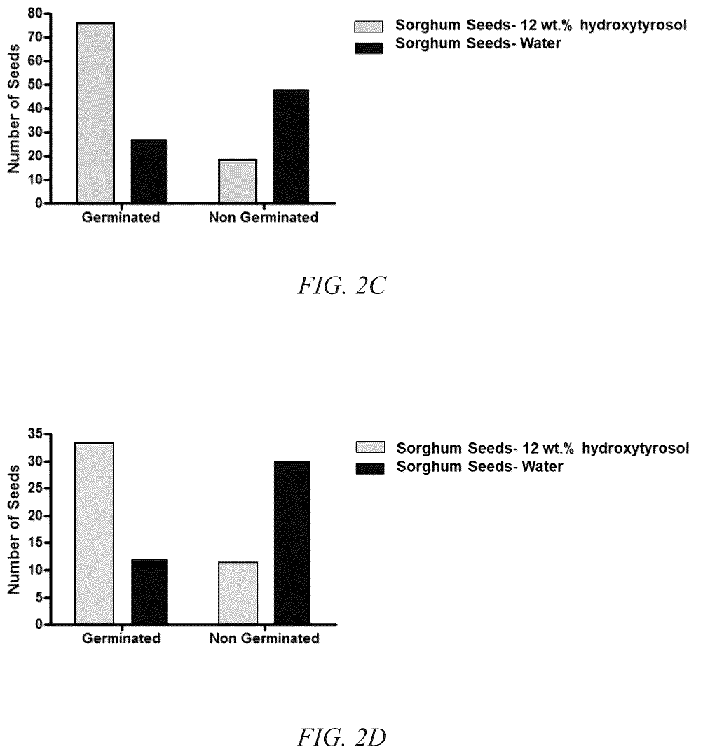

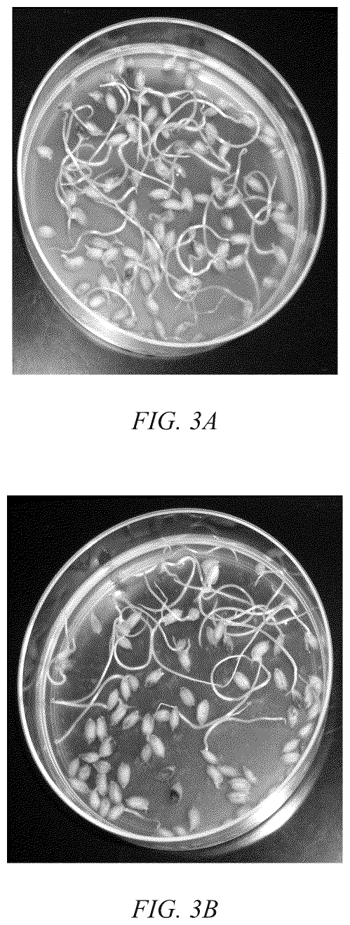

FIG. 2A depicts a photographic image of the sorghum seeds incubated in the 12 wt. % hydroxytyrosol solution after 14 days. FIG. 2B is a photographic image of the sorghum seeds incubated in water after 14 days. As observed in FIGS. 2A and 2B, a greater number of germ tubes emerged from the sorghum seeds that were incubated in the 12 wt. % hydroxytyrosol solution, compared to the sorghum seeds incubated in water. For example, FIG. 2C is a bar chart showing the number of germinated and non-germinated sorghum seeds after being incubated in the 12 wt. % hydroxytyrosol solution, relative to the control. As observed in FIG. 2C, 78% of the sorghum seeds incubated in the 12 wt. % hydroxytyrosol solution germinated, compared to 36% of the sorghum seeds incubated in water.

Consistent results were observed when the above-described protocol was repeated. For example, as observed in FIG. 2D, 77% of the sorghum seeds incubated in the 12 wt. % hydroxytyrosol solution germinated, compared to 29% of the sorghum seeds incubated in water. As also observed in Example 1, the solutions including 12 wt. % hydroxytyrosol inhibited bacterial growth, compared to samples incubated in water.

### Example 3—Rice Seed Germination

Rice seeds (Japanese cultivar, Taipei 309) were incubated at 37° C. in a solution including 12 wt. % hydroxytyrosol for 14 days. As a control, rice seeds (Japanese cultivar, Taipei 309) were incubated at 37° C. in water for 14 days.

FIG. 3A depicts a photographic image of the rice seeds incubated in the 12 wt. % hydroxytyrosol solution after 14 days. FIG. 3B is a photographic image of the rice seeds incubated in water after 14 days. As observed in FIGS. 3A and 3B, a greater number of germ tubes emerged from the rice seeds that were incubated in the 12 wt. % hydroxytyrosol solution, compared to the rice seeds incubated in water. For example, 74% of the rice seeds incubated in the 12 wt. % hydroxytyrosol solution germinated, compared to 56% of the rice seeds incubated in water.

### Example 4—Rice Growth Rate

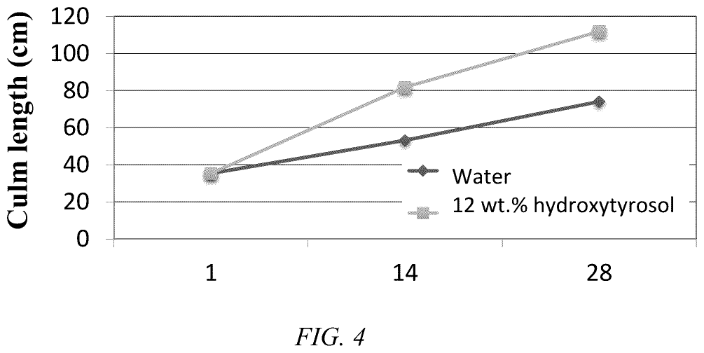

Rice plants were treated with 12 wt. % hydroxytyrosol over 28 days. As a control, rice plants were treated with water over 28 days. FIG. 4 depicts a line chart showing the column length of rice plants over 28 days. Table 1 provides the column length of rice plants treated with 12 wt. % hydroxytyrosol and water after 1, 14, and 28 days.

TABLE 1
Effects of Hydroxytyrosol Treatment

| | Days of Treatment | | |
|---|---|---|---|
| | 1 | 14 | 28 |
| Water (Control) | 22 cm | 39 cm | 60 cm |
| 12 wt. % hydroxytyrosol | 35 cm | 82 cm | 112 cm |

As observed in FIG. 4 and Table 1, treating rice plants with 12 wt. % hydroxytyrosol increased the growth rate of the rice, compared to rice plants treated with water. For example, the column length of rice plants was 112 cm after being treated with 12 wt. % hydroxytyrosol for 28 days, the column length of rice plants treated with water for 28 days was 60 cm.

### Example 5—Protein Production

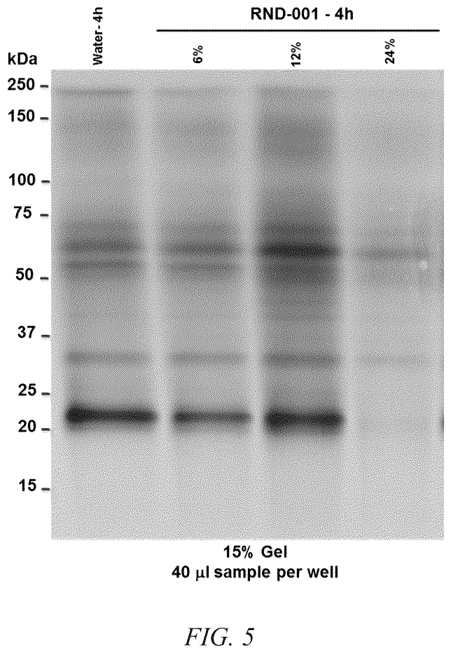

The treatment of crops with a solution of hydroxytyrosol also increased the protein production of the crop. For example, FIG. 5 depicts an image of a western blot showing the protein levels in leaves, after being treated with 6 wt. %, 12 wt. %, and 24 wt. % hydroxytyrosol, relative to a control sample treated water. 40 μl of the respective samples were loaded per well of a 15% gel. As shown in FIG. 5, the treatment with 12 wt. % hydroxytyrosol increased the protein levels in leaves by five-fold, compared to the protein levels in leaves treated with water.

### Example 6—Variation in Hydroxytyrosol Concentration

The effect of different hydroxytyrosol concentrations on crop stress resistance and protein production was examined. The four treatment groups included: a control group where plants were treated with water, a group treated with 6% BioPropello, a group treated with 12% BioPropello, and a group treated with 24% BioPropello. Protein quantification was conducted using SDS-PAGE and Western blotting for visualization, followed by densitometry analysis to measure fold increases in protein expression. Additionally, HPLC-DAD and mass spectrometry were utilized to confirm hydroxytyrosol stability and retention in plant tissue.

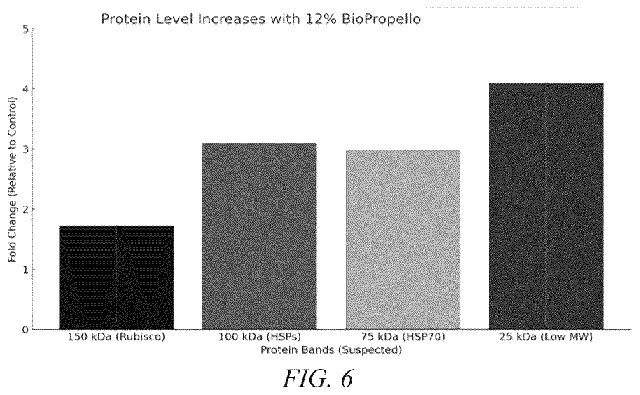

FIG. 6 depicts quantification of the fold change in protein expression following application of 12% by weight hydroxytyrosol. As can be seen in FIG. 6, treatment with 12% hydroxytyrosol led to a 4.09× increase in low molecular weight proteins (sHSPs, LTPs, pathogenesis-related proteins, and LEA proteins), a 2.99× increase in HSP70, a 3.10× increase in other HSPs, and a 1.72× increase in Rubisco, enhancing plant resilience to drought and heat stress. Unexpectedly, a desensitization effect was observed at 24% hydroxytyrosol, where protein expression decreased below levels seen at 12%. While the present disclosure is not bound to any particular theory or potential mechanism of action, it is noted that this unexpected result suggests a metabolic regulation threshold that suppresses protein synthesis beyond a certain point. The potential mechanism of action revealed, for example, that 12% hydroxytyrosol stimulates protein synthesis and stress tolerance, whereas excessive polyphenol accumulation at 24% triggers a feedback loop to reduce protein expression and mitigate oxidative stress. This discovery thus unveils a previously unknown and unappreciated regulatory mechanism involved in plant polyphenol interactions; the present disclosure relates, at least in part, to the practical application of insights flowing from this discovery.

1-23. (canceled)

24. A composition comprising hydroxytyrosol obtained from an olive tree,
wherein the hydroxytyrosol concentration is from about 0.1% to about 20% by weight,
wherein the effect of the composition is at least one of the following: enhancing uptake of nutrient by a crop; improving soil microorganisms associated with the crop; improving the tolerance to abiotic stress of the crop; improving the health of the crop; improving the vigor of the crop; increasing the protein production of the crop; and increasing the harvest yield of the crop.

25-27. (canceled)

28. The composition of claim 24, wherein the concentration of the hydroxytyrosol is from about 0.1% to about 20% by weight.

29-32. (canceled)

33. The formulation of claim 28, wherein the hydroxytyrosol concentration is below a level that suppresses protein expression.

34. A process for making a formulation for agricultural use from biomass comprising:
hydrolyzing the biomass;
filtering the biomass; and
extracting hydroxytyrosol from the biomass,
wherein the biomass comprises at least one of the following: olive pomace or olive mill wastewater.

35. The process of claim 33, further comprising heating the biomass at a temperature over about 75° C.

36. The process of claim 33, wherein filtering the biomass comprises at least ultrafiltration or nanofiltration.

37. A biostimulant composition comprising:
an olive leaf extract;
a polyphenol complex;
an aqueous or organic solvent carrier suitable for agricultural application

38. The composition of claim 37, wherein the composition comprises less than about 24% hydroxytyrosol.

39-42. (canceled)

43. The composition of claim 37, wherein the polyphenol complex comprises one or more flavonols, flavones, flavanols.

44-45. (canceled)

46. The composition of claim 37, wherein application of the extract to a crop seed increases protein expression as compared to expression of the protein prior to application of the composition.

47. The composition of claim 46, wherein the protein comprises Rubisco or a heat shock protein (HSP).

48. (canceled)

49. The composition of claim 46, wherein application of the composition to a crop seed increases protein expression by up to about 10-fold as compared to expression of the protein prior to application of the composition.

50-52. (canceled)

53. The composition of claim 37, wherein application of the composition to a crop seed improves abiotic stress resistance as compared to abiotic stress resistance prior to application of the composition.

54. The composition of claim 53, wherein the stress resistance comprises heat stress resistance, drought resistance, or salinity resistance.

55-56. (canceled)

57. The composition of claim 37, wherein application of the composition to a crop seed enhances crop growth as compared to crop growth prior to application of the composition.

58. The composition of claim 37, wherein application of the composition to a crop seed enhances germination rate of the crop seed as compared to germination rate of the crop seed prior to application of the composition.

59. The composition of claim 37, wherein application of the composition to a crop seed increases photosynthetic efficiency as compared to photosynthetic efficiency prior to application of the composition.

60-86. (canceled)

87. The composition of claim 57, wherein application of the composition to a crop seed enhances crop growth by up to 1000% as compared to crop growth prior to application of the composition.

88. The composition of claim 58, wherein application of the composition to a crop seed enhances germination rate of the crop seed by up to 1000% as compared to germination rate of the crop seed prior to application of the composition.

89. The composition of claim 59, wherein application of the composition to a crop seed increases photosynthetic efficiency by up to 1000% as compared to photosynthetic efficiency prior to application of the composition.
